(19) United States
(12) Patent Application Publication
(10) Pub. No.: US 2009/0121861 A1
(43) Pub. Date: May 14, 2009

(54) Detecting, deterring security system

(76) Inventors: Joel Pat Latham, Arlington, TX (US); Steven Wayne Belden, Lucas, TX (US); Greig Stovall Latham, Lucas, TX (US); Barry Arthur Hall, Bowie, TX (US); Michael A. Ramsey, Doubleoak, TX (US); Matt Kyle, Garland, TX (US)

Correspondence Address: Steven Thrasher, 391 Sandhill Dr., Richardson, TX, 75080, US

(21) Appl. No.: 12/011,539

(22) Filed: Jan. 26, 2008

Related U.S. Application Data
(60) Provisional application No. 61/002,975, filed on Nov. 14, 2007.

(51) Int. Cl. G08B 13/00; G08B 25/00

(52) U.S. Cl. 340/522; 340/541; 340/550

(57) ABSTRACT

A security system used to detect, deter, and/or document security events and information from a secured area. The security system may include an intelligence system for distinguishing between false alarms and actual alarm events. The security system may also include multiple deter devices actionable upon detection of an actual alarm event. The security system may further include a security event data collection system that collects event or alarm data pertaining to security events either onsite or remote and a video/camera system that records images of security events.

### CROSS REFERENCE TO RELATED APPLICATIONS

This application is related to two copending applications filed on the same day as the present application, the contents of both being incorporated herein by reference. One is entitled, “A Method for Detecting Events at a Secured Location”, Ser. No. ______, and assigned to the same assignee as the present application. The second related application entitled, “A Security System and Network”, Ser. No. ______, and also assigned to the same assignee as the present application

### TECHNICAL FIELD

The present invention relates to security systems and, more specifically, security systems having a mobile component for use in securing outdoor locations or large indoor locations.

### BACKGROUND OF THE INVENTION

Security systems are known in the art and a typical security system is located for the purpose of securing a defined area and discouraging unwanted and illegal activities such as trespassing, theft, sabotage. The defined area that is secured by the security system will usually comprise a closed area, such as a specified room(s) within a building, or an entire building or house.

All security systems have certain basic elements in common. All include one or more sensors that are used to sense an entry event or other activity that could be viewed as an unauthorized trespassing, theft, sabotage. The sensors are coupled, usually with electrical wires, to a central control. When an entry or other activity is detected by the sensor, a signal is sent to the central control, which generates an alarm signal. The alarm signal may be used locally to sound an audible alarm or to inform local security personnel. The alarm signal may also be used to signal a remote location, such as a police station.

More sophisticated security systems supplement this basic security system with additional sensors (e.g., that sense the opening of the security box itself, the presence of motion within the secured area, and detection of smoke or fire). Such systems may also include backup battery protection and remote paging capabilities, but all lack to ability to use sensors to distinguish and/or learn to distinguish between a false detection and an actual alarm condition. They also lack sufficient ability to deter trespassing, theft, and/or sabotage by individuals.

### SUMMARY OF THE INVENTION

The present invention provides a security system for monitoring an area from intruders. The security system includes an enclosure for weather protection of the intelligent system, a detector device, and a deter device. The security system also includes at least one power source for providing power to the security system and a programmable determination device mounted within the enclosure, wherein the programmable determination device is for activating a deter measure in response to a detection signal from the detector.

In another aspect, the present invention provides a security system for monitoring an area from intruders. The security system includes an enclosure for weather protection of the intelligent system, a detector device, and a deter device, wherein the enclosure, the detector device, and the deter device can be mounted on a rigid structure within the monitored area. The security system also includes a battery and a programmable determination device mounted within the enclosure, wherein the programmable determination device is for activating a deter measure in response to a detection signal from the detector.

In another aspect, the present invention provides a security system for monitoring an area from intruders. The security system includes an enclosure for weather protection of the intelligent system, a detector device, and a deter device, wherein the enclosure, the detector device, and the deter device can be mounted on a rigid structure within the monitored area. The security system also includes a battery and a programmable determination device mounted within the enclosure, wherein the programmable determination device is for activating a deter measure in response to a detection signal from the detector. Further, the programmable determination device is an object recognition device capable of recognizing objects within the monitored area in a first condition and in a second condition.

In another aspect, the present invention provides a security system including a plurality of power sources for providing electrical power to the security system, a security event detection system including a visual detection device for detecting a security event and responsive thereto generating data indicative of the security event, a programmable determination device for receiving the security event data and initiating deter measures, a deter device actuated by the programmable determination device upon a determined security event, and a data collection system configured to collect and store security event data.

In another aspect, the present invention provides a portable security system for protection of property within an outdoor area monitored for human interaction, the security system including a security event detection system including a video surveillance device configured to provide images of surrounding objects and further configurable to detect security events sensed from other sensing devices, a programmable determination device for receiving the object images and sensed security event data and responsive thereto determining if an alarm condition is present for initiating a deter measure, wherein the programmable determination device is capable of object condition recognition such that objects within the monitored outdoor area are first recorded in a first condition and a security event is initiated if any one of the objects are determined to be in a condition different from the first condition, wherein the conditions are provided via a further scan provided from the video surveillance device, and a deter device actuated by the programmable determination device upon a determined alarm condition, wherein the deter device in at least one of a plurality of detection devices selected from a group comprising a two-way audio device, a strobe light, a siren, and a spray emitter, and wherein the two-way audio device enables an monitor operator to converse with anyone present in the monitored area, wherein the security event detection system and the deter device are attached to a rigid structure and the programmable determination device is contained in a weather proof enclosure which is also attached to the rigid structure.

### BRIEF DESCRIPTION OF THE DRAWINGS

FIG. 1 illustrates a security system with system components in accordance with an embodiment of the present invention;

FIG. 2 illustrates the security system components and other components in accordance with an embodiment of the present invention; and

FIG. 3 illustrates the security system components mounted on a rigid structure in accordance with an embodiment of the present invention.

### DETAILED DESCRIPTION

Whether involved in site preparation, drilling, extraction, or cleanup, a company's financial commitment is immense. Each step represents an investment of hundreds of thousands, if not millions of dollars—an investment worth protecting. The present invention is an advanced system which can be self-contained, self-powered analytics system that protects investments.

The present invention offers real-time event detection. One can monitor the exact location of choice—large or small—and can designate specific activities to detect. Once designated, the specific area to be monitored, the present invention's video/cameras can capture activity occurring in the monitored area. These images are transferred to the present invention's Intelligence system (IS) 14 for real-time analysis and the IC can define what constitutes a security event for the location being monitored. So whether concerned about intruders, theft, sabotage, or unusual changes in the area monitored, the present invention's security system can detect them automatically and accurately. When an event occurs, the present inventions input/output can send alerts immediately using methods such as email, text message, or a phone call using wireless or hard wire.

With the use of specialized sensors, the present invention can also be programmed to detect and alert about events, such as equipment failure, movements or lack of movement, change in temperature or pressure, change in sound levels, glass breakage, and detection of smoke.

The present invention also can deter events before they occur, discouraging unwanted and/or illegal activities such as trespassing, theft, and sabotage. For example, by broadcasting a customized, audible warning to anyone detected in the monitored zone, intruders are sure to know they are being watched. Additionally, the present invention can include remote two-way conversation at the security site, which allows two-way conversation with a remote monitor and anyone detected in the monitored zone.

Once an image, audio, and other data has been analyzed, it can be transferred to a to a storage device such as a Digital Video Recorder (DVR), or similar device, where it is captured in an easily searchable format. Event data captured can be used for training the present system of normal/abnormal detection events, for documentation of practice, or as evidence. Normal activity can be archived at lower rates to conserve storage space and bandwidth. At regular intervals, event data can be transferred wirelessly to a secure datacenter for storage. Once in the datacenter, the data can be archived in a non-erasable, non-modifiable format ensuring the security and preservation of the original data.

Utilizing pre-arranged access to the present invention's security system a remote monitor can access the security system or data for review and use. Additionally, copies of any archived video, audio, or other data can be provided on CD/DVD or archive tape.

In addition, the present invention can provide Video Analytics capability for routine monitoring for management purposes. This live video stream can be available 24 hours a day and allows a remote monitor to observe daily activities such as: Contractors on site, delivery of materials and supplies, employee activities, engineering management, and regular inspection.

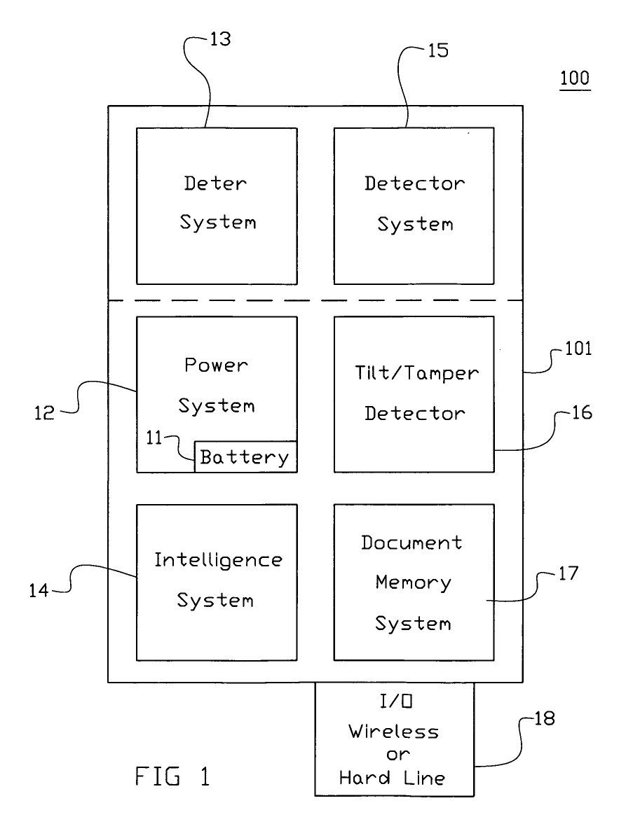

Now referring to FIG. 1, the security system 100 includes a power system 12 (including a battery 11), an Intelligence system 14, a detector system 15, a deter system 13, and an input/output 18. The security system 100 may also include a document memory system 17 and a tilt/tamper detector 16. The battery 11, the Intelligence system 14, the input/output 18, the document memory system 17, and the tilt/tamper detector 16 are contained in a weather proof control box 101 in one embodiment. The tilt/tamper detector 16 detects unauthorized movement or opening of the control box 101. Further, the detector system 15 and the deter system 13 are located outside the control box 101 but are in communication with components in the control box 101. Although the present security system 100 is preferred as an outdoor system, it could also be used to monitor indoor areas.

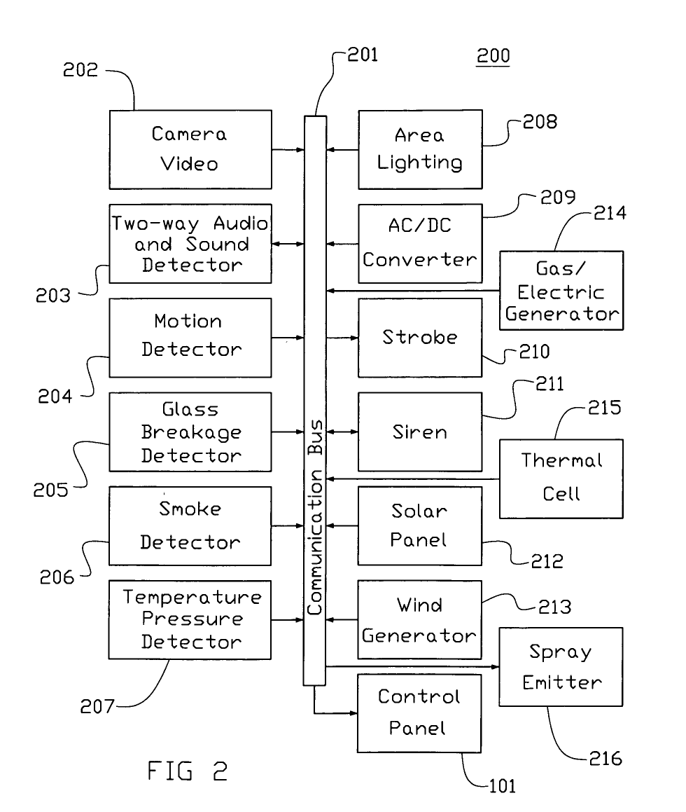

The Intelligence system 14 can include an object/image recognition system and a sound recognition system connectable with any of the sensory devices of the detector system 15 (shown in FIG. 2) and particularly to the video surveillance system 202 and sound detector 203. The Intelligence system 14 is configured to recognize objects and sounds disposed around the monitored area (e.g., equipment, supplies, tools, and other objects meant to be monitored against theft and sabotage and sounds such as dogs, etc.) and objects that may enter the monitored area (e.g., people, animals, motorized vehicles, etc.). The Intelligence system 14 receives video from the video surveillance system 202 or sound system 203 and analyzes the video and sound to determine if an object has left, been moved from, or entered the monitored area. The object and sound recognition system of the Intelligence system 14 can compare data representative of the detected objects or sounds with data representative of known objects or sound. Thus, the intelligence system 14 can recognize objects in a first condition and determine if there has been a condition in which the objects have been moved or removed from the monitor area. It further could determine if an object has entered the monitored area. In either case, the intelligence system 14 would initiate a deter measure and/or and may also initiate a communication with the document memory system 17 or may initiate a communication with a monitoring operator through the I/O device 18.

To enable the Intelligence system 14 it can include a computing device, such as a computer or a DSP for performing object and sound recognition and alarm conditions analysis using information received from the sensing devices of FIG. 2. Further, it should be apparent that video from the video surveillance system 202 (and any other detector device, power source, or deter device) can be communicated to the control box 101 and to the object recognition system included within the Intelligence system 14 in a number of ways including a bus 201, hard wires, coaxial connector, or a wireless connection (for example by using a system utilizing the Bluetooth protocol, or integrated WiFi).

The video/camera surveillance system 202 can include multiple video/cameras which can be oriented in a fixed direction or the positioning can be controlled, for example, to adjust the pan-tilt-zoom of the video/camera and/or to position at various viewing angles using techniques known to those skilled in the art. When the video/camera surveillance system 202 captures images, the date is transmitted to either the intelligence system 14 or the document memory system 17 which can be a multimedia server such as a digital video recorder (DVR) or a computing device. The intelligence system 14 can also include a video encoder that encodes digitized video data that may be received from the video/camera surveillance system 202, and a stream manager that manages the stream of video data for transmission to the document memory system 17 and/or the input/output 18 for transmission over a wireless network, for example.

The input/output 18 can include a wireless interface and can be implemented using wireless technologies known to those skilled in the art such as the short-range radio technology known as Bluetooth or integrated WiFi, and various longer-range radio technologies such as cellular protocols.

Now referring to FIG. 2, the system 200 includes the deter system 13, the detector system 15, the communication bus 201 and the control box 101. The detector system 15 can include any system for detecting and/or collecting security event data including, but not limited to, a motion detector 204 (which can include inferred technology), a video/camera surveillance system 202, a glass breakage detector 205, temperature and pressure detector 207, a smoke/fire detector 206, and an audio detector 203. When security events are detected, the detector system 15 generates event or alarm data indicative of the detected event for transmission to the intelligence system 14. The event or alarm data can include time stamps indicating a time of occurrence of the events as well as information describing the location of the event and the nature of the event or alarm.

The deter system 13 can include any system for deterring humans or animals from unauthorized activities within the monitored area and can include, but is not limited to, the two-way audio device 203, area lighting 208, a strobe 210, a siren 211, and a spray emitter 216. When security events are detected by the detector system 15 and the results are analyzed by the intelligence system 14, any one of the components of the deter system 15 can be activated. For example, by broadcasting a customized, audible warning to anyone detected in the monitored zone (e.g., you are being watched and recorded), intruders are put on notice. Additionally, the present invention can include remote two-way conversation at the security site, which allows two-way conversation with a remote monitor and anyone detected in the monitored zone. Further, a strobe 210 or siren 211 can be activated. And still further, a spray emitter 216 can be activated to emit either an odor which may be offensive to humans or animals, or a dye can be emitted which can be readily seen in light or darkness, or may be detectable under an ultraviolet light.

The power system 12 can include, but is not limited to, a battery 11, an AC source 209, a thermal cell 215, a solar panel 212, a gas generator 214, or a wind generator 213. In a preferred embodiment, the security system 100 operates from the battery which is recharged by any one of the listed power sources. Further, the battery 11 is preferably located in the weather proof control box 101. Additionally, the battery 11 can act as a backup power supply if a primary power supply (e.g., the AC source 209, the thermal cell 215, the solar panel 212, the gas generator 214, or the wind generator 213) is interrupted. Further, the tilt/tamper detector 16 could be arranged to detect interrupt of power supply and used to initiate deter measures and/or initiate communication of a security event.

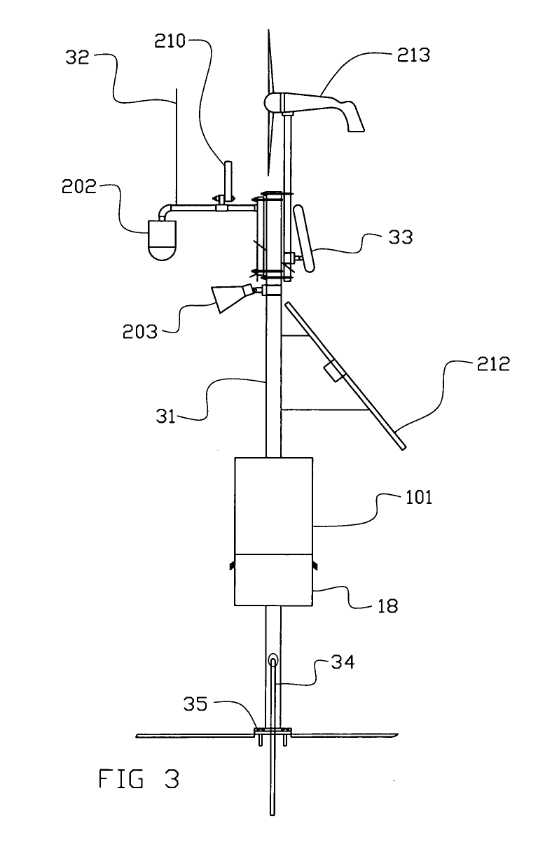

Now referring to FIG. 3, there is illustrated a mounting embodiment of the present invention. As shown, the control box 101, the detect components (as shown, for example, the video/camera 202 and other sensing devices 33), the deter components (as shown, for example, the two-way audio device 203), and the power components (as shown, for example, the solar panel 212 and the wind generator 213) are mounted to a ridged structure, such as a pole 31. As shown, the pole 31 is coupled to the ground 35, but the ridge structure could also be a mobile base which could be rolled into place. Also shown are an earth grounding rod 34 and an antenna for wireless communications. Additionally, the control box 101 and the other components could be mounted to separate ridge structures and/or mobile structures.

Additionally, the security system 100 can include a remote database (not shown) that receives and stores the security data from the security system input/output 18 and from the video surveillance system 202. The remote database can notify an access device of an event and deliver event data together with video data related to the event, for example, in an event message. Alternatively, the access device can initiate communication with the security system 100 to access the security data in the remote database. The access device can be used to view the event data and to play back the video associated with the event.

The access device can be a portable personal digital assistant, a cellular telephone, pager, personal computer, computer terminal, or laptop computer. Those skilled in the art should recognize that the access device can connect to and communicate with the security system 100 in a variety of ways. The connection can be over the internet or through a wireless network such as a wireless local area network, a cellular wide area network, integrated WiFi, or over Bluetooth. The access device can also connect directly to the security system 100 through an access point and can receive data directly from the input/output 18 or the video surveillance system 202.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A security system comprising:
a plurality of power sources for providing electrical power to the security system;
a security event detection system including a visual detection device for detecting a security event and responsive thereto generating data indicative of the security event;
a programmable determination device for receiving the security event data and initiating deter measures;
a deter device actuated by the programmable determination device upon a determined security event; and
a data collection system configured to collect and store security event data.

2. The security system of claim 1 wherein the security event detection system further includes a plurality of detection devices selected from a group comprising of at least one visual detection device, at least one motion detection device, at least one sound detection device, at least one glass breakage detection device, at least one smoke detection device, at least one temperature detection device, at least one pressure detection device, at least one tamper detection device all configured to detect security events and generate data indicative of the security event.

3. The security system of claim 1 wherein the plurality of power source includes at least two of a list comprising a battery, a thermal cell, a photovoltaic panel, wind generator, a gas generator, and an AC power source.

4. The security system of claim 1 further comprising and input/output device which includes a wireless transceiver for remotely accessing the security system.

5. The security system of claim 4 further informing an operator of a security event via the wireless transceiver.

6. The security system of claim 4 further including an alarm notification system configured to notify a mobile access device of a security event via the wireless transceiver.

7. The security system of claim 1 further comprising a video surveillance system configured to record images of security events and to generate video data and further wherein the programmable determination device is further an object recognition system.

8. The security system of claim 7 wherein the object recognition system can determine a first condition of an object and a second condition of an object via the video surveillance system.

9. The security system of claim 1 further including a sound recognition system for determining whether a detected sound is a known sound.

10. The security system of claim 1 further comprising a wireless transceiver for onsite accessing the security system via integrated WiFi, or the Bluetooth protocol.

11. The security system of claim 1 wherein the deter device includes at least one of a plurality of detection devices selected from a group comprising a two-way audio device, a strobe light, a siren, and a spray emitter.

12. The security system of claim 11 wherein the spray emitter is operable for emitting one of a dye or an odor which is offensive to a human.

13. The security system of claim 1 wherein the plurality of power sources, the security event detection system, the programmable determination device, the deter device, and the data collection system are mounted on a single ridged structure.

14. The security system of claim 1 wherein the power source including a battery, and the programmable determination device, and the data collection system, and an input/output device are included in a weather proof enclosure, and further where the detection system, the deter device are mounted on a rigid structure along with the weather proof enclosure.

15. A portable security system for protection of property within an outdoor area monitored for human interaction, the security system comprising:
a security event detection system including a video surveillance device configured to provide images of surrounding objects and further configurable to detect security events sensed from other sensing devices;
a programmable determination device for receiving the object images and sensed security event data and responsive thereto determining if an alarm condition is present for initiating a deter measure, wherein the programmable determination device is capable of object condition recognition such that objects within the monitored outdoor area are first recorded in a first condition and a security event is initiated if any one of the objects are determined to be in a condition different from the first condition, wherein the conditions are provided via a further scan provided from the video surveillance device; and
a deter device actuated by the programmable determination device upon a determined alarm condition, wherein the deter device in at least one of a plurality of detection devices selected from a group comprising a two-way audio device, a strobe light, a siren, and a spray emitter, and wherein the two-way audio device enables an monitor operator to converse with anyone present in the monitored area, wherein the security event detection system and the deter device are attached to a rigid structure and the programmable determination device is contained in a weather proof enclosure which is also attached to the rigid structure.

16. The portable security system of claim 15 further including a plurality of power sources for providing electrical power to the security system including a battery and at least one device from a list comprising a thermal cell, a photovoltaic panel, wind generator, a gas generator, and an AC source, wherein the battery is contained in the weather proof enclosure.

17. The portable security system of claim 15 wherein the other sensing devices includes a group comprising of at least one of a motion detection device, a sound detection device, a glass breakage detection device, a smoke detection device, a temperature detection device, a pressure detection device, a tamper detection device all configured to detect security events and generate data indicative of the security event and are attached to the rigid structure.

18. The portable security system of claim 15 wherein the spray emitter is operable for emitting one of a dye or odor which is offensive to a human.

19. The portable security system of claim 15 further comprising a wireless transceiver for remotely accessing the security system and further including an alarm notification system configured to notify a mobile access device of a security event via the wireless transceiver.

20. The portable security system of claim 15 further comprising a wireless transceiver for onsite accessing the security system via integrated WiFi, or the Bluetooth protocol.
